(19) United States
(12) Patent Application Publication
(10) Pub. No.: US 2010/0067976 A1
(43) Pub. Date: Mar. 18, 2010

(54) DEVICE COMPRISING AT LEAST A FIRST AND A SECOND MACHINE PART

(75) Inventor: Alexander GOERG, Geisenheim (DE)

Correspondence Address: LUCAS & MERCANTI, LLP, 475 PARK AVENUE SOUTH, 15TH FLOOR, NEW YORK, NY, 10016, US

(73) Assignee: MVS DYNALINK EUROPE GMBH, Liederbach (DE)

(21) Appl. No.: 12/561,546

(22) Filed: Sep. 17, 2009

(30) Foreign Application Priority Data
Sep. 18, 2008 (DE) 20 2008 012 454.9

(51) Int. Cl. F16D 1/12

(52) U.S. Cl. 403/134

(57) ABSTRACT

The invention relates to a device comprising at least a first (1) and a second (2) machine part, wherein the machine parts (1, 2) are movable, especially pivotable, relatively to another, wherein a sealing boot (3) is arranged for sealing the first machine part (1) against the second machine part (2), wherein the sealing boot (3) has a first ring groove (4), in which a first spring element (5) is inserted, by which spring element (5) the sealing boot (3) is pressed against the first machine part (1) in the region of the first ring groove (4), and/or wherein the sealing boot (3) has a second ring groove (6), in which a second spring element (7) is inserted, by which spring element (7) the sealing boot (3) is pressed against the second machine part (2) in the region of the second ring groove (6). To facilitate the assembly of the device, the invention is characterized in that the first machine part (1) comprises a slide bearing shell and the second machine part (2) comprises a sphere which is arranged at an axle, wherein the sphere is supported by the slide bearing shell, wherein the spherical joint, which is formed by the slide bearing shell and the sphere, is part of a connecting link in a vehicle and wherein the first and/or the second spring element (5, 7) are designed as a closed ring, wherein the ring consists of a spring wire which is bent helically.

The invention relates to a device comprising at least a first and a second machine part, wherein the machine parts are movable, especially pivotable, relatively to another, wherein a sealing boot is arranged for sealing the first machine part against the second machine part, wherein the sealing boot has a first ring groove, in which a first spring element is inserted, by which spring element the sealing boot is pressed against the first machine part in the region of the first ring groove, and/or wherein the sealing boot has a second ring groove, in which a second spring element is inserted, by which spring element the sealing boot is pressed against the second machine part in the region of the second ring groove.

Devices of this type are required in order to secure two parts, for example in vehicle wheel suspension systems, which execute certain movements in operation, relative to each other. Fastening elements of this type are also referred to as coupling rods, connecting links and stabilizer links. They serve for transferring forces and strokes. In vehicles, they connect e. g. the stabilizer at a front wheel with the axle guide, wherein forces during cushioning and rebound of the wheel are transmitted and thus the driving behaviour of the vehicle is stabilized during driving across an uneven road.

Thereby, normally the two connected machine parts comprise a ball joint, wherein a ball (sphere), which is arranged at the end of an axle, is supported in a slide bearing shell. For a long lifetime of the ball joint it must be protected especially against the invasion of contamination and humidity. Thus, it is known to mount a sealing boot, which is fixed statically with its axial ends at the housing of the bearing shell and at the axle, which bears the ball, respectively.

The static fixation of the sealing boot is effected by two spring elements which are inserted in ring grooves in the sealing boot and thus fix the sealing boot at those locations of the housing of the bearing shell and of the axle, which bears the ball, respectively.

Spring rings, which are slotted at a circumferential position, are used as spring elements, which extend in the ring groove along substantially more than 360° to establish a firm connection between the sealing boot and the machine part. In the mounted state the spring ring extends along almost 720° , i. e. along almost two revolutions. Only by doing so the spring ring—arranged in the ring groove of the sealing boot—exerts a sufficient pressing force on the sealing boot, so that the sealing boot abuts tightly on the machine part.

Thereby, it is a disadvantage that the automatic assembly of the spring ring is relatively difficult. It often occurs that the two windings of the spring ring are not arranged side by side after the assembly but intersect each other. Then, manually reworking is required to bring the spring ring into the right position.

Furthermore, it is a drawback that the spring ring does not constitute a consistent radial pressing force along the entire circumference of the ring groove of the sealing boot, in which it is mounted, due to its design. Caused by the open ends of the spring ring an uneven pressing force is exerted on the sealing boot and thus the static sealing effect between the sealing boot and the machine part is not always optimal.

Thus, it is an object of the present invention to further develop a device of the kind mention above, so that the assembly of the sealing boot and the cooperating machine part is facilitated and stabilized. Furthermore, it is aimed that the spring element exerts an optimal constant pressing force along the entire circumference at which the sealing boot contacts the machine part.

According to the invention, the solution of this object is characterized in that the first machine part comprises a slide bearing shell and the second machine part comprises a sphere which is arranged at an axle, wherein the sphere is supported by the slide bearing shell, wherein the spherical joint, which is formed by the slide bearing shell and the sphere, is part of a connecting link in a vehicle and wherein the first and/or the second spring element are designed as a closed ring, wherein the ring consists of a spring wire which is bent helically.

The first and/or the second ring groove can have a shape in a radial cross section which corresponds to the outer contour of the helically bent spring wire. Especially, the first and/or second ring groove can have a semi-circular contour in a radial cross section.

Preferably, the spring wire consists of stainless steel.

The diameter of the spring wire is preferably between 0.2 and 0.6 mm. The outer diameter of the helical structure of the spring wire is mostly between 1.0 and 4.0 mm, preferably between 1.4 and 2.3 mm.

Preferably, the spring element is formed by a straight extending helically bent spring wire, wherein the both axial ends of the helically bent spring wire are connected with another.

The straight extending helically bent spring wire can have a section at one axial end, in which section the outer diameter of the helical structure of the spring wire has a reduced diameter compared with the remaining section of the helically shaped structure of the spring wire.

By this, it is possible in a beneficial manner, that—according to a further embodiment of the invention—the section with reduced diameter is screwed in the other axial end of the helically bent spring wire.

Mostly, the sealing boot consists of rubber. But it is also possible, that the sealing boot consists of plastic, especially of a thermoplastic elastomer based on urethane (TPU).

By the proposed design of the spring element it becomes possible that the assembly process of the spring element is facilitated and stabilized, so that the rework, which was necessary till now, can be avoided. Consequently, the device can be produced in a more economic way.

A further significant advantage of the invention is that a constant radial pressing force is exerted along the entire circumference of the ring groove, in which the spring element is inserted, so that the static sealing between the machine part and the sealing boot is improved.

The drawing shows an embodiment of the invention.

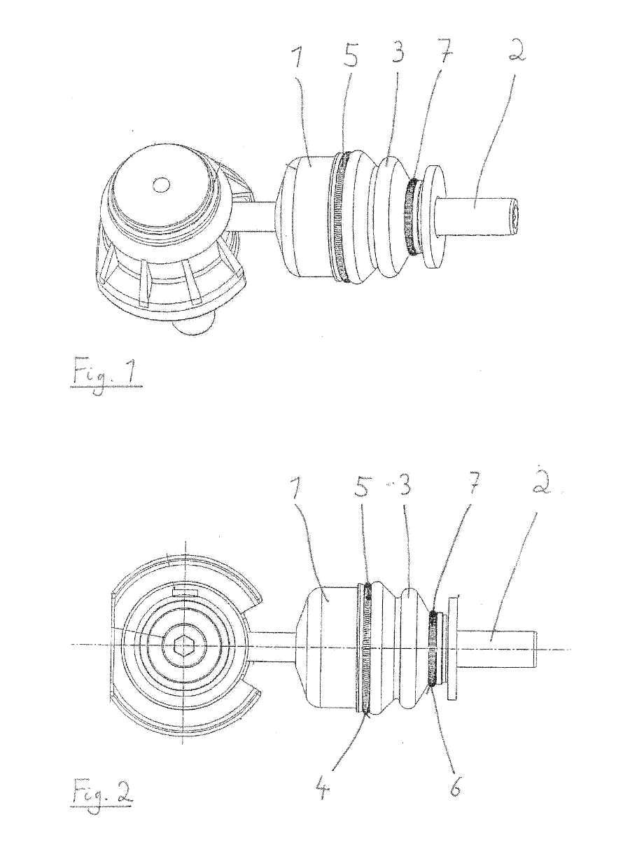

FIG. 1 shows in a perspective view a device consisting of two cooperating machine parts which are sealed with a sealing boot, wherein the device comprises a ball joint,

FIG. 2 shows the side view of the device according FIG. 1,

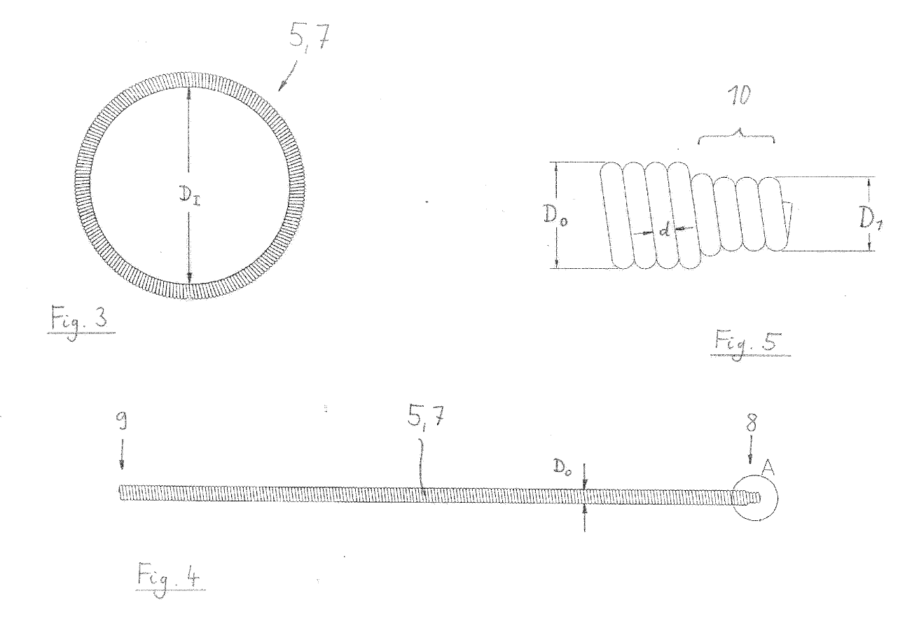

FIG. 3 shows a top plan view of a sealing ring for the static fixation of the sealing boot,

FIG. 4 shows the spring ring according FIG. 4 before its completion as a semi-finished part and

FIG. 5 shows the detail “A” according to FIG. 4.

In FIGS. 1 and 2 a device is shown which comprises among other things two machine parts 1 and 2. The machine part 1 is a housing of a ball joint, in which a slide bearing shell is arranged. The machine part 2 is an axle, wherein a ball or sphere (not depicted) is arranged at the (left) end of the axle, which is arranged in the slide bearing shell. The ball joint which is constituted in the mentioned way is sealed by a sealing boot 3.

The device is a coupling rod in the present case and is used to connect two parts (not depicted) in a chassis of a vehicle relatively to another, so that strokes and forces can be transmitted from one part of the chassis to another.

In order to fix the axial ends of the sealing boot 3 at the two machine parts 1 and 2 static firmly, the sealing boot 3 has ring grooves 4 and 6 in its axial end regions (see FIG. 2), namely a first ring groove 4 and a second ring groove 6. In the ring grooves 4, 6 a spring element 5 and 7 respectively is mounted, namely a first spring element 5 in the first ring groove 4 and a second spring element 7 in the second ring groove 6.

Importantly, at least the first or the second spring element, preferably both spring elements, are designed as a closed ring. This ring consists of a helical bent spring wire.

Details to this are apparent from FIGS. 3 till 5.

In FIG. 3 the finished spring ring 5, 7 is depicted which it to be mounted in the ring grove 4, 6. It has a circular design and consists of a helical bent spring wire. The inner diameter D_{I} of the ring is marginally smaller than the diameter of the ground of the ring groove 4, 6 in a not yet mounted state, so that after the assembly a sufficient radial pressing force being directed to the inner side is exerted by the spring element 5, 7. The inner diameter is preferably between approximately 10 mm and 55 mm, dependent on the sealing boot on which the spring element 5, 7 is to be mounted.

In FIG. 4 the helical bent spring wire is depicted as a semi-finished part, i. e. before it is assembled to the ring 5, 7. The semi-finished part which extends here still straightly has a fine helical structure, which is formed by a wire, which has a diameter d which is preferably between 0.2 and 0.6 mm. The present helical structure has an outer diameter D₀ which is normally between 1.0 and 4.0 mm.

To form the spring ring 5, 7 according to FIG. 3 the two axial ends 8 and 9 of the semi-finished part according to FIG. 4 must be connected.

A preferred solution for doing so is that the helical structure according FIG. 4 has a section 10 at one axial end 8 with a smaller outer diameter D₁ as depicted in FIG. 5.

The outer diameter of this section 10 is chosen in such a way that it is suitable—dependent on the diameter d of the wire—to be “screwed” into the other axial end 9 of the semi-finished part according to FIG. 4. Then, the helical windings of the section 10 contact with their outer circumference the inner circumference of the helical windings in the region of the axial end 9, so that a positive fit is established like in the case of a screw.

For instance, the reduced outer diameter D₁ can be approximately 1.3 mm in the case of a diameter d of the wire in the region of 0.35 mm and an outer diameter D₀ of the helical structure of 1.8 mm.

This production process can be automated. Thereby, before the “screwing” of the axial end 8 into the axial end 9 the semi-finished part according to FIG. 4 is firstly turned by a respective number of revolutions against the direction of the screwing direction, so that after the screwing a twisting-free spring element 5, 7 is on hand.

### LIST OF REFERENCE NUMERALS

1 First machine part
2 Second machine part
3 Sealing boot
4 First ring groove
5 First spring element
6 Second ring groove
7 Second spring element
8 Axial end
9 Axial end
10 Section with reduced diameter
D_{I} Inner diameter
d Outer diameter of the spring wire
D₀ Outer diameter of the helical structure
D₁ Reduced outer diameter

1. Device comprising: a first and a second machine part, pivotable, relatively to another, a sealing boot arranged for sealing the first machine part against the second machine part, the sealing boot having a first ring groove, in which a first spring element is inserted, the spring element pressing the sealing boot against the first machine part in the region of the first ring groove, and/or the sealing boot having a second ring groove, in which a second spring element is inserted, the spring element pressing the sealing boot against the second machine part in the region of the second ring groove,
the first machine part comprises a slide bearing shell, the second machine part comprises a sphere which is arranged at an axle, wherein the sphere is supported by the slide bearing shell, wherein the spherical joint, which is formed by the slide bearing shell and the sphere, is part of a connecting link in a vehicle and wherein the first and/or the second spring element are designed as a closed ring, wherein the ring consists of a spring wire which is bent helically.

2. Device according to claim 1, wherein the first and/or the second ring groove have a shape in a radial cross section which corresponds to the outer contour of the helically bent spring wire.

3. Device according to claim 2, wherein the first and/or second ring groove have a semi-circular contour in a radial cross section.

4. Device according to claim 1, wherein the spring wire consists of stainless steel.

5. Device according to claim 1, wherein the diameter (d) of the spring wire is between 0.2 and 0.6 mm.

6. Device according to claim 1, wherein the outer diameter (D₀) of the helical structure of the spring wire is between 1.0 and 2.0 mm, preferably between 1.4 and 2.3 mm.

7. Device according to claim 1, wherein the spring element is formed by a straight extending helically bent spring wire, wherein the two axial ends of the helically bent spring wire are connected with another.

8. Device according to claim 7, wherein the straight extending helically bent spring wire has a section at one axial end, in which section the outer diameter of the helical structure (D₀) of the spring wire has a reduced diameter (D₁) compared with the remaining section of the helically shaped structure of the spring wire.

9. Device according to claim 8, wherein the section with reduced diameter (D₁) is screwed in the other axial end of the helically bent spring wire.

10. Device according to claim 1, wherein the sealing boot consists of rubber.

11. Device according to claim 1, wherein the sealing boot consists of plastic, especially of a thermoplastic elastomer based on urethane (TPU).
